(19) United States
(12) Patent Application Publication
(10) Pub. No.: US 2007/0229989 A1
(43) Pub. Date: Oct. 4, 2007

(54) Clear vieu

(76) Inventors: Randall Scott, Abbotsford (CA); Nancy MacDonald, Abbotsford (CA)

Correspondence Address: Raymond M. Galasso;Galasso & Associates LP, P.O. Box 26503, Austin, TX, 78755-0503, US

(21) Appl. No.: 11/731,652

(22) Filed: Mar. 30, 2007

Related U.S. Application Data
(60) Provisional application No. 60/787,424, filed on Mar. 30, 2006.

(51) Int. Cl. G02B 27/02

(52) U.S. Cl. 359/802

(57) ABSTRACT

Clear Vieu is a magnifying sheet with an adhesive layer that is dimensioned to fit on a variety of display screens for computers, cell phones, personal digital assistants, game boys, blackberries and a variety of other electronic equipment. The preferred embodiment of the invention utilizes a thin, transparent plastic sheet with magnifying capabilities that has an adhesive layer with a backing to permit it to be easily attached to a display screen. To use the preferred embodiment of Clear Vieu, an individual would measure the display screen in need of magnification and purchase an appropriately sized plastic sheet. The user would remove the backing on the plastic sheet to reveal the adhesive layer. The adhesive layer side of the plastic sheet would be applied to the designated display screen and would be firmly pressed against it. The magnifying capabilities of the plastic sheet would then permit the user to more easily see the characters on the display screen underneath the plastic sheet.

### CROSS REFERENCE TO RELATED APPLICATIONS

This United States Non-Provisional patent application claims priority to U.S. Provisional Patent Application No. 60/787,424 entitled “Clear Vieu” filed on Mar. 30, 2006.

### FIELD OF THE DISCLOSURE

The disclosures made herein relate generally to the computer and electronics accessories industries. The invention discussed herein is in the general classification of magnification devices for display screens.

### BACKGROUND

Individuals are increasingly using electronic equipment having display screens for work and pleasure. Computers, game boys, blackberries, personal digital assistants, and cell phones are just some of the most popular pieces of electronic equipment with display screens. Unfortunately, consistent work or play on such devices can be taxing on the eyes. Many experience vision problems from straining to view the small type on display screens. Those individuals with impaired vision have particular trouble viewing these screens and the small type displayed on these screens.

Traditionally, individuals have either foregone the use of these types of devices or carried eye equipment such as glasses to help in viewing the display screens of these devices. Some even must utilize a magnifying device in order to properly read the characters displayed on the screen.

The most common devices for magnifying an object are a traditional magnifying lens and a Frensel lens. A traditional magnifying lens usually utilizes a convex glass lens to bend light such that the viewed object will appear larger. A Frensel lens is flat on one side and ridged on the opposite side. The angled ridges focus light toward the center to make viewed objects appear larger. However, carrying this magnification equipment can be cumbersome and using a traditional magnifying device while reading the screen can be tedious.

Hence, there is a need in the art for a convenient to use, inexpensive, durable, safe and effective device for adhering to and providing magnification for display screens on computers and other electronic devices.

### SUMMARY OF THE DISCLOSURE

Clear Vieu is a magnifying sheet with an adhesive layer that is dimensioned to fit on a variety of display screens for computers, cell phones, personal digital assistants, game boys, blackberries and a variety of other electronic equipment.

The preferred embodiment of the invention utilizes a thin, transparent plastic sheet with magnifying capabilities that has an adhesive layer with a backing to permit it to be easily attached to a display screen.

The principal object of this invention is to provide a device that magnifies the images on display screens for computers or other electronic devices.

Another object of this invention is to provide a device to aid the elderly or visually impaired view the display screens of various electronic equipment.

Another object of this invention is to provide a device that easily adheres to a display screen and provides magnification of the display screen.

Another object of this invention is to provide an affordable device for providing magnification of a display screen.

Another object of this invention is to provide a safe device for providing magnification of a display screen.

Another object of this invention is to provide a device that is easily used for providing magnification of a display screen.

Yet another object of this invention is to provide a durable device for providing magnification of a display screen.

### BRIEF DESCRIPTION OF THE DRAWINGS

FIG. 1 depicts a frontal view of the preferred embodiment of the present invention being attached to the display screen of a cellular telephone.

FIG. 2 depicts a perspective view of the preferred embodiment of the present invention being applied to a game boy screen.

### DETAILED DESCRIPTION OF THE DRAWINGS

The preferred embodiment of Clear Vieu is comprised of at least some of the following: a thin, transparent plastic sheet with magnifying capabilities that has an adhesive layer with a backing to permit it to be easily attached to a display screen.

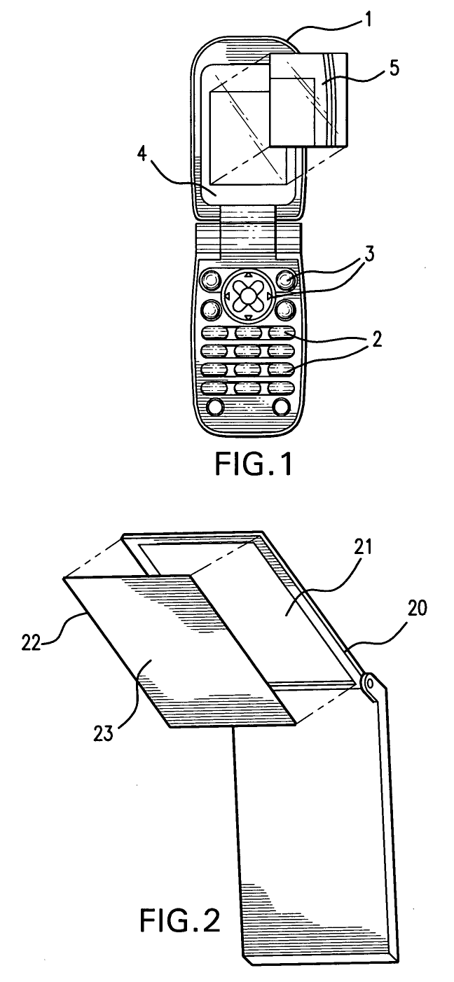

FIG. 1 depicts a frontal view of the preferred embodiment of the present invention being attached to the display screen of a cellular telephone. The housing 1 of the cellular phone can be easily seen along with the alphanumeric keys 2 and the various function/control keys 3 of the cellular phone. As with almost all cellular phones, a display screen 4 is located inside the housing 1. The display screen 4 is rectangular in shape on this phone as it is on most cellular phones.

A plastic sheet 5 that is dimensioned to cover approximately the entirety of the display screen 4 is shown being attached to the display screen 4. The plastic sheet 5 has magnifying capabilities. A convex design or a ridged Fresnel design could be employed to provide the magnifying capabilities of the preferred embodiment of the plastic sheet 5. The plastic sheet 5 is transparent and rectangular in this preferred embodiment though alternative designs could utilize plastic sheets that were not completely clear and of a variety of shapes to conform to any given shape display screen.

An adhesive layer (not visible) is located on the back of the plastic sheet 5. The adhesive layer covers the entirety of the back of the plastic sheet 5 in this preferred embodiment. A plastic backing (not shown) is placed over this adhesive layer until the plastic sheet 5 is ready to be applied to the display screen 4.

FIG. 2 depicts a perspective view of the preferred embodiment of the present invention being applied to a game boy screen. A traditional game boy has a housing 20 with a display screen 21.

A plastic sheet 22 that is dimensioned to cover approximately the entirety of the display screen 21 is shown being attached to the display screen 21. The plastic sheet 22 has magnifying capabilities. A convex design or a ridged Fresnel design could be employed to provide the magnifying capabilities of the preferred embodiment of the plastic sheet 22. The plastic sheet 22 is transparent and rectangular in this preferred embodiment though alternative designs could utilize plastic sheets that were not completely clear and of a variety of shapes to conform to any given shape display screen.

An adhesive layer (not visible) is located on the back of the plastic sheet 22. It covers the entirety of the back of the plastic sheet 22 in this preferred embodiment. A plastic backing 23 is placed over this adhesive layer until the plastic sheet 22 is ready to be applied to the display screen 21.

To use the preferred embodiment of Clear Vieu, an individual would measure the display screen in need of magnification and purchase an appropriately sized plastic sheet. The user would remove the backing on the plastic sheet to reveal the adhesive layer. The adhesive layer side of the plastic sheet would be applied to the designated display screen and would be firmly pressed against it. The magnifying capabilities of the plastic sheet would then permit the user to more easily see the characters on the display screen underneath the plastic sheet.

The materials utilized for Clear Vieu may vary widely but will likely include plastic components.

The plastic used in the production will ideally be selected for durability and longevity. Thermoplastics are commonly used in the manufacturing of components similar to those used in this invention. Polyethylene, polypropylene, and other similar thermoplastic materials would be among those with the necessary traits. Members of this family are recognized universally as being versatile and of high quality.

The plastic components of Clear Vieu can also be formed with the use of plastic molding techniques, such as injection molding or blow molding. Injection molding requires melted plastic to be forcefully injected into relatively cool molds. As the plastic begins to harden, it takes on the shape of the mold cavity. This technique is ideal for the mass production of products. Alternatively, blow molding, a form of extrusion, could be utilized. Blow molding involves a molten tube being pushed into a mold. Compressed air then forces the molten tube against the cold walls of the mold.

It should be obvious that the components of the present invention can be of various shapes and sizes. It should also be obvious that the components of the invention can be made of different types of plastics or other suitable materials and can be of any color.

It will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

What is claimed is:

1. A device for use with a display screen comprising:
(a) a sheet with magnifying capabilities dimensioned to cover the display screen; and
(b) an attaching mechanism on the sheet.

2. The device of claim 1 wherein the sheet is plastic.

3. The device of claim 1 wherein the sheet is glass.

4. The device of claim 1 wherein the sheet is approximately rectangular.

5. The device of claim 1 wherein the sheet covers the entirety of the display screen

6. The device of claim 1 wherein the sheet is transparent.

7. The device of claim 1 wherein the attaching mechanism is an adhesive layer covering approximately the entirety of the rear of the sheet.

8. The device of claim 7 further comprising
a backing for the adhesive layer.

9. The device of claim 8 wherein the backing is plastic.

10. A device for use with a display screen comprising:
(a) a plastic and transparent sheet with magnifying capabilities dimensioned to cover the display screen; and
(b) an adhesive layer with a backing on the rear of the plastic and transparent sheet.
